(19) United States
(12) Patent Application Publication
(10) Pub. No.: US 2011/0039998 A1
(43) Pub. Date: Feb. 17, 2011

(54) ORGANO-NEUTRALIZED DIATOMACEOUS EARTH, METHODS OF PREPARATION, AND USES THEREOF

(75) Inventors: Michael Greene, Goleta, CA (US); Nigel Julian Keith Danvers, Paris (FR); Qingchun Hu, Lompoc, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: World Minerals, Inc., Santa Barbars, CA (US)

(21) Appl. No.: 12/989,883

(22) PCT Filed: May 4, 2009
(86) PCT No.: PCT/US09/42687

§ 371 Date: Oct. 27, 2010

Related U.S. Application Data
(60) Provisional application No. 61/050,618, filed on May 5, 2008.

(51) Int. Cl. C08K 3/34; C08K 5/17; C08K 5/54; C04B 14/04

(52) U.S. Cl. 524/188; 524/448; 524/186; 106/482

(57) ABSTRACT

This application discusses organo-neutralized diatomaceous earth, comprising at least one diatomaceous earth subjected to at least one treatment with at least one basic organic compound. Also disclosed herein is a composition, such as a silicone rubber composition or a paper composition, comprising organo-neutralized diatomaceous earth. Also disclosed herein are methods of making organo-neutralized diatomaceous earth and methods of making silicone rubber formulations comprising a organo-neutralized diatomaceous earth filler.

### CLAIM OF PRIORITY

This PCT international application claims the full rights of priority to, and the benefits of, U.S. Provisional Patent Application No. 61/050,618 filed May 5, 2008, which is incorporated by reference herein in its entirety.

### DESCRIPTION OF THE INVENTION

1. Field of the Invention

Disclosed herein is an organo-neutralized diatomaceous earth and uses thereof. Also disclosed herein are compositions comprising organo-neutralized diatomaceous earth. Further disclosed herein are improved silicone rubber compositions comprising organo-neutralized diatomaceous earth, as well as improved paper compositions comprising organo-neutralized diatomaceous earth. Also disclosed herein are methods of making organo-neutralized diatomaceous earth, as well as methods of making a silicone rubber compositions comprising organo-neutralized diatomaceous earth.

2. Background of the Invention

Silicone rubber is generally weaker in comparison to conventional elastomers. Its main advantage is that it generally retains better strength at elevated temperatures; thus, it is mainly used where high temperature is important. For that reason, the heat aging effects of fillers used in silicone rubbers may be important.

In general, two distinct types of fillers used in polymer compositions, such as rubber compositions—known as primary fillers and secondary fillers. The function of a primary filler is generally to improve the hardness and strength of the composition, which may be weak when unfilled. Exemplary primary fillers include, but are not limited to, silica fillers such as fumed silica, crystalline silica, and precipitated silica. A secondary filler is often used in conjunction with a primary filler, and its function is generally to replace as much of the more expensive polymer as possible, without undue loss of strength. An exemplary secondary filler includes, but is not limited to, fine quartz.

Polymer compositions, such as rubbers, and their fillers are generally segregated by market applications into extrusion applications and molding applications. Fillers that release water at processing temperatures (such as, for example, precipitated silicas and natural diatomaceous earth) are generally unsuitable for extrusion applications, but may be acceptable for molding applications.

The use of primary silica fillers, such as surface neutralized synthetic silicas, may be costly and may also raise concerns from a material hazard standpoint. Therefore, there is a need to find replacements or extensions of primary silica fillers without compromising the properties of the final polymer product.

Diatomaceous earth products are obtained from diatomaceous earth (also called “DE” or “diatomite”), which is generally regarded as a sediment enriched in biogenic silica (i.e., silica produced or brought about by living organisms) in the form of siliceous skeletons (frustules) of diatoms. Diatoms are a diverse array of microscopic, single-celled, golden-brown algae of the class Bacillariophyceae that possess an ornate siliceous skeleton of varied and intricate structures comprising two valves that, in the living diatom, fit together much like a pill box.

The treatment of diatomaceous earth with amines and silane compounds is generally known. Japanese Patent Application No. 07-196348 discloses the treatment of diatomaceous earth with ammonia, amines, acids, or bases to activate the surface and raise the reactivity of the diatomaceous earth, and then further reacting the diatomaceous earth with polysiloxane oligomers to make materials for cement substitution. U.S. Pat. No. 7,264,728 discloses covalently binding organo-silanes to a diatomaceous earth surface for filtration applications. U.S. Pat. No. 4,713,333 discloses covalently binding polyamine compounds to the surface of diatomaceous earth, and then derivatizing the amine compounds to bind enzymes in filtration applications. Similarly, International Patent Application Publication No. WO 2005/117616 discloses covalently binding silane hydrolysable groups to the surface of diatomaceous earth for beverage filtration applications. U.S. Pat. No. 5,252,762 discloses the treatment of diatomaceous earth with basic compounds in a manner that allows the base to remain in the diatomaceous earth pores, whereby the base may then react with contaminants that filter through the pores in filtration applications. All of those disclosures may relate to covalently binding chemicals to the surface of diatomaceous earth, and none of these references teach or suggest the neutralization of surface acidic sites of diatomaceous earth with basic organo compounds.

The use of diatomaceous earth as a filler in silicone compositions and other compositions is generally known. U.S. Pat. No. 4,382,057 discloses silicone rubber compositions for liquid injection using fillers comprised of fumed silica and calcined diatomaceous earth. U.S. Pat. No. 6,395,855 is directed to quick hardening silicone materials and discloses an acidic or basic neutral salt as an accelerating cross linking agent. Japanese Patent Application No. 2004-123993 discloses a mixture of diatomite, petroleum, photocatalytic TiO₂, methylmethoxysilane, and an optional coupler to prevent silicone oil seeping out of a silicone sealing member. U.S. Pat. No. 6,596,784 discloses using dried diatomaceous earth treated with a coupling agent as a filler in thermoplastics to make stronger, less expensive window treatments; the coupling agent comprises a blend of fatty acid, metal soap, amide, ethyl bis-stearamide, and increases the compatibility of the diatomaceous earth with resin. None of those references teach or suggest contemplate diatomaceous earth treated with a basic organo compound to neutralize surface acidic sites, nor do the references teach or suggest silicone rubber formulations comprising organo-neutralized diatomaceous earth as a filler, or using diatomaceous earth as a primary filler.

Without wishing to be bound by theory, it is suspected that natural and non-flux calcined diatomaceous earth may have poor curing responses in silicone rubbers due to exposed highly acidic surface sites. Those acidic sites may be due in part to contaminating clay or other impurities. The acidic sites may be present on the diatomaceous earth surface and/or on the impurities. A detrimental reaction may occur between the free-radical initiator in a polymer system and mineral fillers when acidic species, such as Lewis acids, ionically cleave the initiator, making the initiator inert. The resulting inert initiator fragments do not contain free radicals and, therefore, cannot start or propagate a radical chain reaction. In a compounded silicone rubber system, for example, the degree and efficiency of cross-linking reactions may be greatly affected by acid cleavage, which may lead to no cure or a poor cure with poor rubber-like properties.

The present inventors have surprisingly found that treatment of diatomaceous earth with at least one basic organic compound may produce organo-neutralized diatomaceous earth, in which at least some of the surface acidic sites of the diatomaceous earth have been at least partially neutralized. The performance of diatomaceous earth as a filler in silicone rubbers may be improved. Without wishing to be bound by theory, it is speculated that the at least one basic organic compound at least partially neutralizes at least some of the acidic sites on the surface of the diatomaceous earth and/or contaminating clay. Use of the organo-neutralized diatomaceous earth may, for example, provide a novel filler for silicone rubber that, in some embodiments, provides improved mechanical properties for extrusion and molding applications. In one embodiment, the organo-neutralized diatomaceous earth is used as a filler in silicone rubber formulations. In another embodiment, the organo-neutralized diatomaceous earth is used as an additive in paper compositions.

### SUMMARY OF THE INVENTION

Disclosed herein is an organo-neutralized diatomaceous earth, comprising at least one diatomaceous earth comprising at least one acidic surface site at least partially neutralized by at least one basic organic compound.

Also disclosed herein is an organo-neutralized diatomaceous earth, comprising at least one diatomaceous earth subjected to at least one treatment with at least one basic organic compound in an amount sufficient to at least partially neutralize at least one surface acid site of the diatomaceous earth.

Further disclosed herein are compositions, including but not limited to silicone rubber compositions and paper-based compositions, comprising an organo-neutralized diatomaceous earth comprising at least one diatomaceous earth treated with at least one basic organic compound.

Further disclosed herein are methods of making organo-neutralized diatomaceous earth. Also disclosed herein are methods of making silicone rubber compositions comprising at least one filler comprising at least one organo-neutralized diatomaceous earth.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 is a tensile data plot for Compound #2 of Example 1.

FIG. 2 is a tensile data plot for Compound #5 of Example 1.

FIG. 3 is a graph illustrating the initial Mooney viscosity of the compositions tested in Example 2.

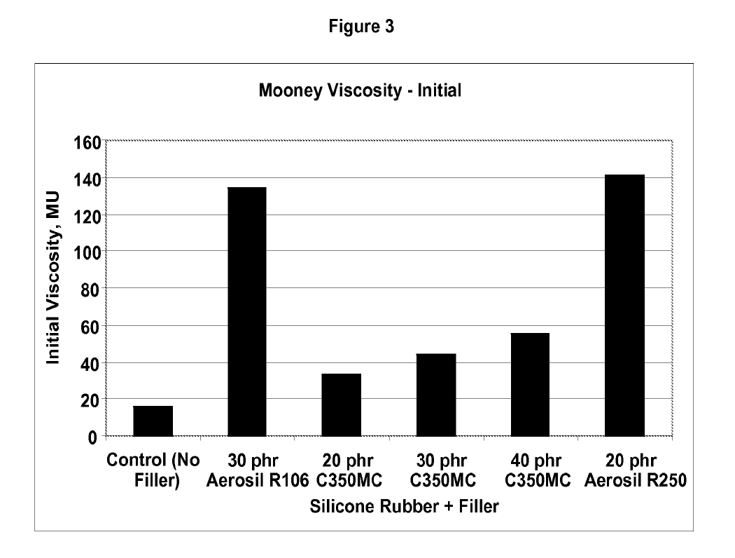

FIG. 4 is a graph illustrating the Mooney viscosity at four minutes of the compositions tested in Example 2.

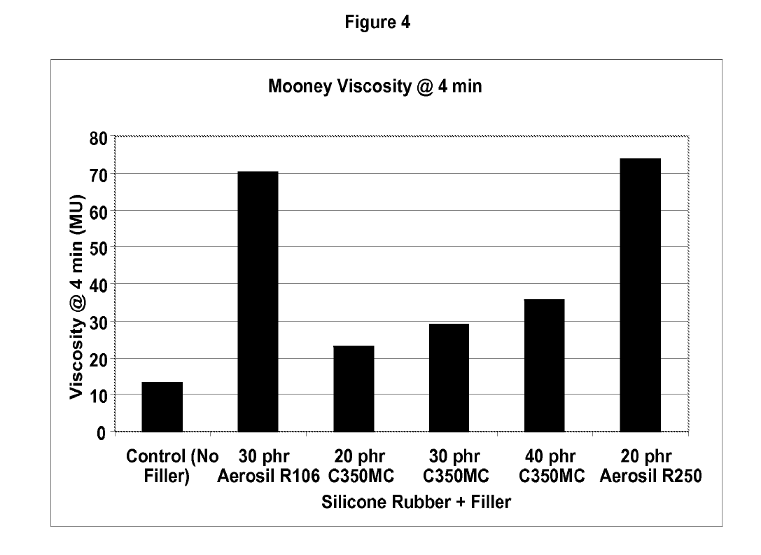

### DESCRIPTION OF THE EMBODIMENTS

At least one diatomaceous earth comprising at least one acidic surface site is subjected to at least one treatment with at least one basic organic compound in an amount sufficient to at least partially neutralize the at least one acidic surface site to produce an organo-neutralized diatomaceous earth. As used herein, “organo-neutralized” is intended to signify at least one diatomaceous earth subjected to at least one treatment with at least one basic organic compound, such that at least one of the acidic surface sites (e.g., Lewis acids) of the diatomaceous earth particle and/or at least one impurity is at least partially reduced, neutralized, or deactivated, i.e., the acid potential of the surface acidic sites is reduced. As used herein, the term “neutralized” does not necessarily mean that the pH value surface site or of the diatomaceous earth is 7 or is about 7.

### Diatomaceous Earth

The organo-neutralized diatomaceous earth comprises at least one diatomaceous earth. The skilled artisan will be readily aware of diatomaceous earths presently known or hereafter discovered that would be appropriate for use in compositions and methods disclosed herein. Diatomaceous earth is generally available in the form of particles. In one embodiment, the diatomaceous earth is natural. In another embodiment, the diatomaceous earth is from a saltwater source. In a further embodiment, the diatomaceous earth is marine diatomaceous earth. In yet another embodiment, the diatomaceous earth is from a freshwater source. In yet a further embodiment, the diatomaceous earth is a blend of diatomaceous earth from at least two different sources. In still another embodiment, the diatomaceous earth is calcined. In still a further embodiment, the diatomaceous earth is flux-calcined.

The at least one diatomaceous earth may comprise at least one impurity. In one embodiment, the at least one impurity is present in the form of particles. In another embodiment, the at least one impurity is a clay. In a further embodiment, the at least one impurity is a sulfate. In yet another embodiment, the at least one impurity is a phosphate.

The diatomaceous earth comprises at least one acidic surface site. In one embodiment, the at least one acidic surface site is a Bronsted acid site. In another embodiment, the at least one acidic surface site is a Lewis acid site. One or more acidic surface sites may be present on a diatomaceous earth particle, an impurity particle, or both. In one embodiment, the at least one acidic surface site is present on (or associated with) a diatomaceous earth particle. In another embodiment, the at least one acidic surface site is associated with at least one impurity. In a further embodiment, the at least one diatomaceous earth comprises a plurality of diatomaceous earth particles having one or more acidic surface sites. In yet another embodiment, the at least one diatomaceous earth comprises a plurality of diatomaceous earth particles having one or more acidic surface sites, and a plurality of particles of at least one impurity having one or more acidic surface sites. In yet a further embodiment, the diatomaceous earth comprises at least two acidic surface sites. In such an embodiment, at least a first acidic surface site is associated with a diatomaceous earth particle and at least a second acidic surface site is associated with an impurity particle. In another such embodiment, at least a first acidic surface site is associated with a first diatomaceous earth particle and at least a second acidic surface site is associated with a second diatomaceous earth particle. In a further such embodiment, at least a first acidic surface site is associated with a first impurity particle and at least a second surface acidic site is associated with a second impurity particle.

### Basic Organic Compounds

An organo-neutralized diatomaceous earth comprises at least one diatomaceous earth comprising at least one surface acidic site at least partially neutralized by at least one basic organic compound. The skilled artisan will be readily aware of basic organic compounds presently known or hereafter discovered that would be appropriate for use in compositions and methods disclosed herein. As used herein, an organic compound is a compound comprising a molecular backbone or structure generally comprised of carbon molecules. In one embodiment, the at least one basic organic compound is any basic organic compound that neutralizes, i.e., makes less acidic, at least one surface acidic site in the at least one diatomaceous earth. In another embodiment, the at least one basic organic compound is any molecule that at least partially sterically blocks at least one surface acidic site of the at least one diatomaceous earth and/or the at least one impurity, effectively rendering the site and/or the diatomaceous earth less acidic. In a further embodiment, the at least one basic organic compound is chosen from basic organic compounds with a pKa of greater than about 7. In yet another embodiment, the at least one basic organic compound is chosen from amino acids with a pKa of greater than about 7. In yet a further embodiment, the at least one basic organic compound is chosen from organic compounds comprising at least one basic group chosen from the group consisting of amines, imines, and ammonia. In still another embodiment, the at least one basic organic compound comprises at least one amine group. In still a further embodiment, the at least one amine is chosen from amino ethers, alkanolamines, aminosilanes, ethyleneamines, and aminoesters. In another embodiment, the at least one imine is chosen from ethyleneimines and polyethyleneimines.

One or more acidic surface sites may be at least partially neutralized by one or more basic organic compounds. In one embodiment, at least a first acidic surface site is at least partially neutralized by at least a first basic organic compound and at least a second acidic surface site is at least partially neutralized by at least a second basic organic compound. In another embodiment, at least one acidic surface site is at partially neutralized by at least a first basic organic compound and at least a second basic organic compound. In a further embodiment, at least one acidic surface site associated with the at least one diatomaceous earth is at least partially neutralized by a different at least one basic organic compound than the at least a second acidic surface site associated with an at least one impurity.

In one embodiment, the at least one basic organic compound comprises at least one amine. In one embodiment, the at least one basic compound is chosen from the group consisting of primary, secondary, and tertiary (poly)amines. In another embodiment, the at least one basic compound is methylamine. In a further embodiment, the at least one basic compound is ethylamine. In yet another embodiment, the at least one basic compound is diethylamine. In yet a further embodiment, the at least one basic compound is 1,3-propanediamine.

In another embodiment, the at least one basic organic compound comprises at least one amino ether. In one embodiment, the at least one basic compound is chosen from the group consisting of polyether amines and morpholines. One non-limiting example of a polyether amine is the long chain polyether amine sold by Huntsman Company under the tradename Jeffamines®.

In a further embodiment, the at least one basic organic compound comprises at least one alkanolamine. In one embodiment, the at least one basic compound is chosen from the group consisting of 2-amino-2-methyl-1-propanol (2-AMP), monoethanolamine, diethanolamine, triethanolamine (TEA), monoisopropanolamine, triisopropanolamine, diethylaminoethanol (DEAE), methylethanolamine, dimethylethanolamine, ethylaminoethanol, amino-methypropanol, and alkanolamine aminomethylpropanol (AMP). In another embodiment, the at least one basic compound is alkanolamine aminomethylpropanol (AMP).

In yet another embodiment, the at least one basic organic compound comprises at least one aminosilane. In one embodiment, the at least one basic compound is chosen from the group consisting of 3-aminopropyltrimethoxysilane, N-(2-aminoethyl)-3-aminopropyltrimethoxysilane, trimethoxysilylpropyldiethylenetriamine, 2-(trimethoxysilylethyl)pyridine, N-(3-trimethoxysilylpropyl)pyrrole, trimethoxysilylpropyl polyethyleneimine, bis-(2-hydroxyethyl)-3-aminopropyltriethoxysilane, and bis(2-hydroxyethyl)-3-amino propyltriethoxysilane.

In yet a further embodiment, the at least one basic organic compound comprises at least one ethyleneamine. In one embodiment, the at least one basic compound is chosen from the group consisting of ethylenediamine, diethylenetriamine, piperazine, N-aminoethylpiperazine, triethylenetetramine, tetraethylenepentamine, pentaethylenehexamine, and higher ethylenepolyamines. Exemplary, non-limiting higher ethylenepolyamines are those sold under the name HEPA delamines by Azko Nobel Chemicals. In one embodiment, the higher ethylenepolyamines also act as dispersants.

In still another embodiment, at least one basic organic compound comprises at least one aminoester. In one embodiment, the at least one basic organic compound is chosen from organic compounds comprising ester-substituents chosen from primary, secondary, and tertiary amines of acrylic and methacrylic acids. In another embodiment, the at least one basic organic compound is chosen from N-substituted acrylamides, wherein the alkyl group comprises from 2 to 12 carbon atoms, including but not limited to N-ethylacrylamide, N-tert-butylacrylamide, N-tert-octylacrylamide, N-octylacrylamide, N-decylacrylamide, and N-dodecylacrylamide. In a further embodiment, the at least one basic organic compound is chosen from N-substituted methacrylamides, wherein the alkyl group comprises from 2 to 12 carbon atoms, including but not limited to N-ethylmethacrylamide, N-tert-butylmethacrylamide, N-tert-octylmethacrylamide, N-octylmethacrylamide, N-decylmethacrylamide, and N-dodecylmethacrylamide. In yet another embodiment, the at least one basic organic compound is chosen from the group consisting of aminoethyl, butylaminoethyl, N,N′-dimethylaminoethyl, and N-tert-butylaminoethyl methacrylates.

### Treatment

The at least one treatment of the at least one diatomaceous earth with the at least one basic organic compound is any treatment now known to the skilled artisan or hereafter discovered that, in one embodiment, allows the at least one basic organic compound to neutralize at least one surface acidic site of the at least one diatomaceous earth. In another embodiment, the at least one treatment is any treatment that allows the at least one basic organic compound to at least partially sterically block at least one surface acidic site of the at least one diatomaceous earth. In a further embodiment, the at least one treatment comprises mixing the at least one diatomaceous earth with the at least one basic organic compound. In yet another embodiment, the at least one treatment comprises spraying, misting, mixing, coating in a fluidized bed or paddle mixer, or treatment in a steam mill. In yet a further embodiment, the at least one treatment comprises slurrying the at least one diatomaceous earth in water and mixing the resulting diatomaceous earth slurry with the at least one basic organic compound.

The at least one treatment may comprise exposing the at least one diatomaceous earth to the at least one basic organic compound in the presence of at least one ionizing medium. The at least one ionizing medium may be any medium that allows the at least one diatomaceous earth to be treated with the at least one basic organic compound. In one embodiment, the at least one ionizing medium is at least one aqueous medium. In another embodiment, the at least one ionizing medium is water.

The at least diatomaceous earth may be subjected to at least one treatment with any appropriate amount of the at least one basic organic compound to effect the desired level of neutralization and/or effect the desired properties of the organo-neutralized diatomaceous earth. In one embodiment, the at least one basic organic compound is added in an amount greater than about 0.25% relative to the total weight of the diatomaceous earth. In another embodiment, the at least one basic organic compound is added in an amount greater than about 0.5% relative to the total weight of the diatomaceous earth. In a further embodiment, the at least one basic organic compound is added in an amount greater than about 1% relative to the total weight of the diatomaceous earth. In yet another embodiment, the basic organic compound is added in an amount greater than about 2% relative to the total weight of the diatomaceous earth. In yet a further embodiment, the basic organic compound is added in an amount from about 0.1% to about 5% relative to the total weight of the diatomaceous earth. In still another embodiment, the basic organic compound is added in an amount from about 0.5% to about 2% relative to the total weight of the diatomaceous earth.

In one embodiment, the organo-neutralized diatomaceous earth has a pKa ranging from about 4 to about 7.

### Compositions Comprising Organo-Neutralized Diatomaceous Earth

Various compositions may incorporate the organo-neutralized diatomaceous earth disclosed herein. In one embodiment, the composition is a polymer composition. In another embodiment, the composition is a rubber composition. In a further embodiment, the composition is a natural rubber composition. In yet another embodiment, the composition is a synthetic rubber composition. In yet a further embodiment, the composition is a silicone rubber composition. In still another embodiment, the composition is a paper composition.

The at least one organo-neutralized diatomaceous earth may impart any one or more of various desirable attributes to a composition in which it is incorporated. In one embodiment, the at least one organo-neutralized diatomaceous earth acts as a primary filler. In another embodiment, the organo-neutralized diatomaceous earth acts as a secondary filler. In another embodiment, the at least one organo-neutralized diatomaceous earth provides at least one beneficial increase chosen from hardness, reinforcement properties, cure properties, heat aging characteristics, strength, formulation stability, consistency, lower energy consumption of compounding, and faster extrusion rate.

In one embodiment, a polymer composition comprises at least one polymer and at least one filler comprising at least one organo-neutralized diatomaceous earth. In another embodiment, a polymer composition comprises at least one filler comprising at least one organo-neutralized diatomaceous earth, wherein the at least one organo-neutralized diatomaceous earth comprises at least one diatomaceous earth subjected to at least one treatment with at least one basic organic compound in an amount sufficient to at least partially reduce the activity of at least one surface acidic site of the at least one diatomaceous earth, and at least one polymer.

In one embodiment, a silicone rubber composition comprises at least one silicone polymer and at least one filler comprising at least one organo-neutralized diatomaceous earth. In another embodiment, a silicone rubber composition comprises at least one filler comprising at least one organo-neutralized diatomaceous earth, wherein the at least one organo-neutralized diatomaceous earth comprises at least one diatomaceous earth subjected to at least one treatment with at least one basic organic compound in an amount sufficient to at least partially reduce the activity of at least one surface acidic site of the at least one diatomaceous earth, and at least one silicone polymer.

In one embodiment, a silicone rubber composition comprising at least one filler comprising at least one organo-neutralized diatomaceous earth provides similar or about similar mechanical properties to the silicone rubber product as silica fillers. For example, the mechanical properties of a silicone rubber compounded with 30 parts of organo-neutralized diatomaceous earth can display comparable mechanical properties to a silicone rubber compounded with 30 parts of VN-3 and Aerosil R106, both sold by Degussa.

In one embodiment, a paper composition comprises at least one cellulosic pulp and at least one filler comprising at least one organo-neutralized diatomaceous earth. The skilled artisan is readily aware of cellulosic pulps appropriate for use with the fillers described herein comprising at least one organo-neutralized diatomaceous earth. In another embodiment, a paper composition comprises at least one filler comprising at least one organo-neutralized diatomaceous earth, wherein the at least one organo-neutralized diatomaceous earth comprises at least one diatomaceous earth subjected to at least one treatment with at least one basic organic compound in an amount sufficient to at least partially reduce the activity of at least one surface acidic site of the at least one diatomaceous earth, and at least one cellulosic pulp.

The hardness of a composition comprising at least one organo-neutralized diatomaceous earth may be increased. Hardness may be measured using standard durometers, such as those routinely used for measuring the hardness of rubber compositions. In one embodiment, the Shore A hardness ranges from about 56 to about 90. In another embodiment, the Shore A hardness ranges from about 65 to about 90. In a further embodiment, the Shore A hardness ranges from about 70 to about 80. In yet another embodiment, the Shore A hardness is about 75. In yet a further embodiment, the Shore A hardness is greater than about 65. In still another embodiment, the Shore A hardness is less than about 90.

The tensile strength of a composition comprising at least one organo-neutralized diatomaceous earth may be increased. Tensile strength may be measured, for example, using a H10KS Tensometer with a 1,000 N load cell and a 500 N laser extensometer at a testing speed of 500 mm/min, plus a load range of 100 N. In one embodiment, the tensile strength ranges from about 900 to about 1300 psi. In another embodiment, the tensile strength ranges from about 1000 to about 1200 psi. In a further embodiment, the tensile strength ranges from about 1000 to about 1100 psi. In yet another embodiment, the tensile strength ranges from about 1100 to about 1200 psi. In yet a further embodiment, the tensile strength is about 1160 psi. In still another embodiment, the tensile strength is greater than about 1000 psi.

The tear strength of a composition comprising at least one organo-neutralized diatomaceous earth may be increased. Tear strength is generally known as the tensile force, measured in the same manner as tensile strength, required to tear a pre-slit (notched) specimen. In one embodiment, the tear strength ranges from about 140 to about 190 lbf/in. In another embodiment, the tear strength ranges from about 150 to about 170 lbf/in. In a further embodiment, the tear strength ranges from 155 to 165 lbf/in. In yet another embodiment, the tear strength is greater than about 155 lbf/in.

The modulus value of a composition comprising at least one organo-neutralized diatomaceous earth may be increased. M25, M50, M100, and M200 denote the modulus at 25%, 50%, 100%, and 200% elongation, respectively. Modulus is the tensile stress divided by strain. “Strain” is the length change after elongation divided by the original strength of the specimen. Those of ordinary skill in the art are readily familiar with tests that may be appropriately used to measure modulus values. In one embodiment, the silicone rubber composition as disclosed herein has a modulus value M100 ranging from about 1000 to about 1200 psi. In another embodiment, the modulus value M200 ranges from about 800 to about 1100 psi. In a further embodiment, the modulus value M25 ranges from about 250 to about 300 psi. In yet another embodiment, the modulus value M50 ranges from about 400 to about 450 psi.

The elongation to break of a composition comprising at least one organo-neutralized diatomaceous earth may be increased. Elongation to break is generally measured by stretching the specimen until it breaks. For example, 230% elongation means that specimen breaks when a given dimension is stretched by 230%, and no stretch higher than 230% is achieved in that dimension. Those of ordinary skill in the art are readily familiar with tests that may be appropriately used to measure elongation to break. In one embodiment, the elongation to break ranges from about 200% to about 350%. In another embodiment, the elongation to break ranges from about 230% to about 300%. In a further embodiment, the elongation to break ranges from about 230% to about 270%. In yet another embodiment, the elongation to break ranges from about 230% to about 250%.

The “necking” or flattening of a composition comprising at least one organo-neutralized diatomaceous earth may be decreased. As used herein, “necking” describes a composition, such as a rubber composition, that will not return to its original shape when elongated or stretched. Necking arises from a viscous component, and occurs when the modulus decreases, increases less rapidly, or remains relatively constant with an increase in elongation. In one embodiment, a composition comprising at least one organo-neutralized diatomaceous earth does not show necking or flattening in an elongation range of about 20% to about 80%. In another embodiment, a composition comprising at least one organo-neutralized diatomaceous earth does not show necking or flattening in an elongation range of less than about 100%.

The compression set value of a composition comprising at least one organo-neutralized diatomaceous earth may be increased relative to a composition not comprising at least one organo-neutralizing diatomaceous earth. The compression set value is the thickness change divided by the original thickness and is generally measured after compressing a sample by 25% at 175 ° C. for 22 hours. Those of ordinary skill in the art are readily familiar with tests that may be appropriately used to measure compression set values. In one embodiment, the compression set of a composition comprising at least one organo-neutralized diatomaceous earth ranges from about 5% to about 25%. In another embodiment, the compression set of a composition comprising at least one organo-neutralized diatomaceous earth ranges from about 10 to about 17%. In a further embodiment, the compression set of a composition comprising at least one organo-neutralized diatomaceous earth is lower than the compression set of a compression set comprising at least one filler chosen from the group consisting of precipitated silica, synthetic silica, crystalline silica, and fumed silica, and not comprising at least one organo-neutralized diatomaceous earth.

A organo-neutralized diatomaceous earth may display low rheometer torque. Rheometer torque may be measured, for example, using a ASTM D 2084 standard Monsanto Rheometer at 171 ° C. and 3 ° arc. In one embodiment, the lowest rheometer (ML) torque of a composition comprising at least one organo-neutralized diatomaceous earth ranges from about 3 to about 6 in.lbs. In another embodiment, the lowest rheometer torque of a composition comprising at least one organo-neutralized diatomaceous earth ranges from about 3.4 to about 5.2 in.lbs.

### Silicone Rubber Compositions

In one embodiment, a silicone rubber composition comprises at least one silicone polymer and at least one filler comprising at least one organo-neutralized diatomaceous earth. In another embodiment, a silicone rubber composition comprises at least one filler comprising at least one organo-neutralized diatomaceous earth, wherein the at least one organo-neutralized diatomaceous earth comprises at least one diatomaceous earth subjected to at least one treatment with at least one basic organic compound in an amount sufficient to at least partially reduce the activity of at least one surface acidic site of the at least one diatomaceous earth, and at least one silicone polymer.

In one embodiment, a silicone rubber composition comprising at least one filler comprising at least one organo-neutralized diatomaceous provides similar or about similar mechanical properties to the silicone rubber product as silica fillers. For example, the mechanical properties of a silicone rubber compounded with 30 parts of organo-neutralized diatomaceous earth can display comparable mechanical properties to a silicone rubber compounded with 30 parts of VN-3 and Aerosil R106, both sold by Degussa.

In one embodiment, the silicone rubber compositions disclosed herein display at least one improved processing characteristic relative to silicone rubber compositions comprising at least one filler chosen from fumed silica and precipitated silica. In one embodiment, the at least one improved processing characteristic is lower energy consumption. In another embodiment, the at least one improved processing characteristic is higher extrusion rates.

In one embodiment, at least one organo-neutralized diatomaceous earth is present in the silicone rubber composition in an amount ranging from about 1 to about 200 phr. In another embodiment, at least one organo-neutralized diatomaceous earth is present in the silicone rubber composition in an amount ranging from about 1 to about 100 phr. In a further embodiment, at least one organo-neutralized diatomaceous earth is present in the silicone rubber composition in an amount ranging from about 1 to about 50 phr. In yet another embodiment, at least one organo-neutralized diatomaceous earth is present in the silicone rubber composition in an amount ranging from about 1 to about 30 phr.

The silicone rubber compositions described herein may comprise at least one additive. The skilled artisan will be readily aware of desirable additives and their respective amounts to include in silicone rubber compositions. In one embodiment, the at least one additive is at least one silane, including but not limited to 3-(trimethoxysilyl)propylmethacrylate. In another embodiment, the at least one additive is at least one heat-stabilizing additive, including but not limited to aminomethylpropanol (AMP). In a further embodiment, the at least one additive is at least one mixing aid, including but not limited to N550 Carbon Black. In a further embodiment, the at least one mixing aid is present in an amount of about 1 phr. In yet another embodiment, the at least one additive is at least one peroxide curative, including but not limited to dicumyl peroxide such as DiCup 40C sold by AkroChem Corp. In yet a further embodiment, the at least one mixing aid provides color to the silicone rubber composition. In another embodiment, the at least one additive is at least one additional filler. In one embodiment, the at least one additional filler is chosen from the group consisting of precipitated silica, crystalline silica, and fumed silica.

In one embodiment, a silicone rubber composition comprising at least one organo-neutralized diatomaceous earth is suitable for extrusion applications. In another embodiment, a silicone rubber composition comprising at least one organo-neutralized diatomaceous earth is suitable for molding applications. In a further embodiment, a silicone rubber composition comprising at least one organo-neutralized diatomaceous earth is suitable for use in at least one of seals, gaskets, and o-rings.

A silicone rubber composition comprising at least one organo-neutralized diatomaceous earth may be post cured. In one embodiment, the post cure is performed for 3 to 4 hours at a temperature ranging from 170 to 200° C.

Other than in the examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations and, unless otherwise indicated, the numerical values set forth in the specific examples are reported as precisely as possible. Any numerical value, however, inherently contains certain errors necessarily resulting from the standard deviation found in their respective testing measurements.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

By way of non-limiting illustration, examples of certain embodiments of the present disclosure are given below.

### EXAMPLE 1

### Organo-Neutralized Diatomaceous Earth

Seven diatomaceous earth fillers, designated L-80-0 through L-80-6, were evaluated in peroxide-cured silicone rubber formulations each at a loading level of 30 phr. Three controls were also prepared, including an unfilled base silicone rubber compound, a 30 phr precipitated silica (VN-3 from Degussa) filled compound, and a 30 phr fumed, surface treated silica (Aerosil R106 from Degussa) filled compound. The formulations for these compounds are depicted in Table 1. In each, a 50/50 blend of two silicone rubbers from Dow Corning Corp. (Silastic Q4-4758 and Silastic Q4-4768) was used as the base silicone rubber compound. 1 phr N550 Carbon Black was added as a mixing aid. 1.25 phr peroxide curative (DiCup 40C from AkroChem Corp.) was added to each sample. Superfloss is a flux calcined diatomaceous earth. Compounds #4 through 9 represent calcined diatomaceous earth (Celite C350 from World Minerals), treated with alkanolamine aminomethylpropanol (AMP) in the amount indicated in Table 1.

TABLE 1
Components of Compounds 1-10

| | Compound | | | | | | | | | |
|---|---|---|---|---|---|---|---|---|---|---|
| | 1 | 2 | 3 | 4 | 5 | 6 | 7 | 8 | 9 | 10 |
| | Ingredients | | | | | | | | | |
| | unfilled | | | C350 + | C350 + | C350 + | C350 + | C350 + | C350 + | |
| | rubber | | Super- | 0.25% | 0.50% | 0.75% | 1.0% | 1.5% | 2.0% | Aerosil |
| | control | VN3 | floss | AMP | AMP | AMP | AMP | AMP | AMP | R106 |
| VN-3 | | 30 | | | | | | | | |
| L-80-0 | | | 30 | | | | | | | |
| L-80-1 | | | | 30 | | | | | | |
| L-80-2 | | | | | 30 | | | | | |
| L-80-3 | | | | | | 30 | | | | |
| L-80-4 | | | | | | | 30 | | | |
| L-80-5 | | | | | | | | 30 | | |
| L-80-6 | | | | | | | | | 30 | |
| Aerosil | | | | | | | | | | 30 |
| R106 | | | | | | | | | | |
| Total | 102.25 | 132.25 | 132.25 | 132.25 | 132.25 | 132.25 | 132.25 | 132.25 | 132.25 | 132.25 |

The compounds were mixed in a Haake internal mixer fitted with Banbury style blades at a temperature ranging from 70 to 75° C. The silicone rubber was banded (squeezed and paved on a roller to uniform thickness). Carbon black was evenly spread across the bank. After the black was incorporated, 1 cut was made to each side. Then, the silica was evenly spread across the bank. Three cuts were then made to each side. Finally, DiCup 40C was spread across the bank. After the DiCup was incorporated, 5 cuts were made to each side. 10 end passes were then made, and the grain was set at 30 seconds.

All compounds produced as in Table 1 were tested on a ASTM D 2084 Monsanto Rheometer at 171° C. and 3° arc. The data is depicted in Table 2.

TABLE 2
Cure Characteristics (Rheometer Data)

| | | | | | Tc75 | Tc90 |
|---|---|---|---|---|---|---|
| Compound | MH | ML | Ts2 | Tc50 | (min- | (min- |
| # | (in.lbs) | (in.lbs) | (minutes) | (minutes) | utes) | utes) |
| 1 | 59.01 | 2.47 | 0.95 | 2.02 | 2.94 | 4.41 |
| 2 | 106.79 | 20.49 | 0.84 | 1.72 | 2.5 | 3.52 |
| 3 | 80.43 | 3.40 | 0.79 | 1.83 | 2.64 | 3.93 |
| 4 | 75.99 | 3.73 | 0.87 | 1.81 | 2.50 | 3.62 |
| 5 | 76.03 | 4.67 | 0.87 | 1.85 | 2.52 | 3.58 |
| 6 | 76.41 | 5.00 | 0.88 | 1.89 | 2.59 | 3.71 |
| 7 | 75.57 | 4.87 | 0.86 | 1.84 | 2.53 | 3.62 |
| 8 | 74.93 | 5.08 | 0.89 | 1.92 | 2.64 | 3.77 |
| 9 | 71.95 | 5.12 | 0.91 | 1.95 | 2.69 | 3.82 |
| 10 | 98.72 | 20.26 | 0.96 | 1.94 | 2.75 | 4.79 |

The two compounds with silica fillers (#2 with precipitated silica and #10 with fumed, surface treated silica) displayed a significant increase in the lowest torque (ML) compared to the unfilled compound. The corresponding increase in ML for compounds comprising organo-neutralized diatomaceous earth was much smaller. One implication may be that the viscosity of the compounds comprising silica fillers was higher than fillers comprising organo-neutralized diatomaceous earth. This may translate into improved processing, such as lower energy consumption and/or higher extrusion rates for compounds comprising organo-neutralized diatomaceous earth.

All seven compounds comprising organo-neutralized diatomaceous earth gave an increase (12.94 to 21.42 in.lbs) in MH (maximum torque) compared to that for the unfilled compound (74473-1). The two silica fillers, however, gave a much larger increase in MH (39.71 and 47.78 in.lbs). This difference was, at least in part, due to the much smaller particle sizes of the silica fillers.

All fillers, except Aerosil R106, gave a very slight increase in scorch (lower Ts2) and an increase in cure rate (lower Tc90) compared to the unfilled compound.

### Tensile and Tear Strength Properties

Table 3 depicts the data for hardness, tensile properties, and tear strength compounds 1 through 10 disclosed in Table 1. The tensile slabs were cured for 5 minutes at 171° C. All samples were post cured for 4 hours at 177° C.

TABLE 3
Hardness, Tensile & Tear Strength

| | | | | | | Tensile | Elong. to | Tear |
|---|---|---|---|---|---|---|---|---|
| | Hardness | M25 | M50 | M100 | M200 | Strength | break | Strength |
| Compound # | Shore A | (psi) | (psi) | (psi) | (psi) | (psi) | (%) | (lb f/in) |
| 1 | 56 | 112.0 | 146.9 | 217.9 | 438.3 | 1367.8 | 460.3 | 132.8 |
| 2 | 90 | 459.2 | 468.8 | 547.6 | n/a | 854.3 | 174.8 | 144.0 |
| 3 | 75 | 272.3 | 403.2 | 614.9 | 827.5 | 1023.3 | 329.6 | 163.8 |
| 4 | 75 | 265.8 | 420.2 | 724.1 | 1034.8 | 1105.4 | 243.8 | 158.5 |
| 5 | 75 | 287.6 | 438.5 | 735.7 | 1031.1 | 1127.7 | 264.6 | 158.1 |
| 6 | 76 | 294.6 | 445.9 | 746.8 | 1044.9 | 1106.1 | 238.1 | 160.5 |
| 7 | 76 | 291.9 | 431.9 | 716.2 | 1016.6 | 1105.5 | 255.0 | 157.9 |
| 8 | 76 | 292.9 | 426.8 | 707.9 | 1017.7 | 1130.6 | 271.5 | 160.3 |
| 9 | 76 | 295.4 | 425.1 | 717.8 | 1065.7 | 1160.2 | 254.4 | 156.5 |
| 10 | 90 | 544.4 | 551.5 | 583.8 | 869.7 | 1202.9 | 265.0 | 169.3 |

As expected, the unfilled compound (#1) gave the lowest hardness. The two compounds containing silica fillers gave the highest hardness. The compounds comprising organo-neutralized diatomaceous earth gave Shore A in the range from 75 to 76.

The tensile strength was highest for the unfilled compound and was lowest for the compound with VN-3 filler (precipitated silica). Compound # 3 with filler L-80-0 had a tensile strength of 1023.3 psi, while compounds 4 through 9 with fillers L-80-1 through L-80-6 had tensile strengths in a narrow range and approached the tensile strength of compound #10 with Aerosil R106.

Elongation to break was highest for the unfilled compound, second highest for the L-80-0 compound (#3), and lowest for the VN-3 containing compound. The remaining compounds were essentially equivalent in this respect.

The tear strength was lowest for the unfilled compound, and second lowest for the VN-3 containing compound. All of the compounds with organo-neutralized diatomaceous earth fillers were largely similar in tear strength values that were marginally lower than that for compound with Aerosil R106 silica.

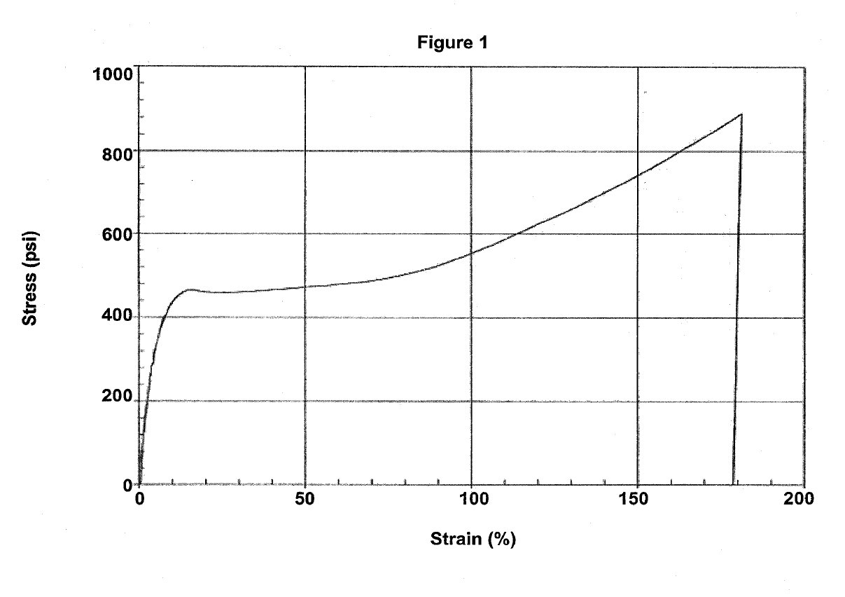

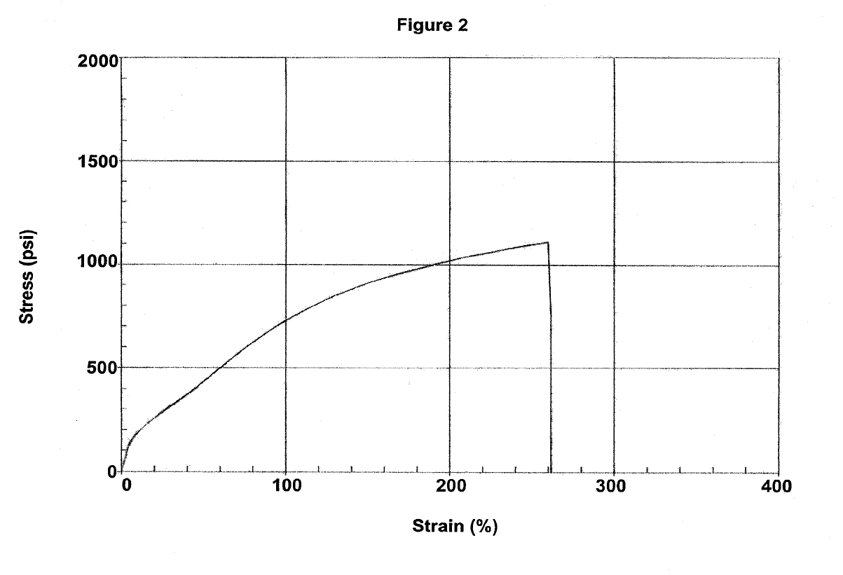

The moduli values (M25, M50, M100 and M200) for the compounds comprising organo-neutralized diatomaceous earth displayed an interesting and unexpected trend when compared with the corresponding values for the two compounds with the prior art silica fillers. The M25 and M50 values are higher for the compounds comprising the prior art silica fillers but the M100 and M200 values are higher for the compounds containing the organo-neutralized diatomaceous earth fillers. This may mean that there is a crossover in the load-elongation curves for the compounds with silica fillers and the organo-neutralized diatomaceous earth fillers. For example, the tensile data plots shown in FIGS. 1 and 2 show distinctly different shapes for Sample 5 (in FIG. 2), a compound comprising a organo-neutralized diatomaceous earth filler, compared to Sample 2 (in FIG. 1), a compound comprising a silica filler. FIG. 1 showed “necking” or flattening in the 20-80% elongation range that was not seen in FIG. 2. That necking behavior is believed to be detrimental to the performance of the silica-filled compounds in applications that involve tensile strains above about 20% because the rubber may not return to its original shape once stretched beyond that point. In fact, once stressed past the start of the necking stress threshold level, the rubber may quickly deform further to the end of the necking strain region. The tensile data revealed that organo-neutralized diatomaceous earth fillers may avoid that problem.

### Compression Set

The compression set data for all compounds is shown in Table 4. Compression set buttons were cured for 10 minutes at 171° C., and post-cured for 4 hours at 177° C. in an oven. The compression set was measured after subjecting the samples to 25% strain at 175° C. for 22 hours.

TABLE 4
Compression Set

| Compound # | Compression Set (%) |
|---|---|
| 1 | 6.1 |
| 2 | 16.8 |
| 3 | 13.3 |
| 4 | 10.5 |
| 5 | 10.6 |
| 6 | 12.6 |
| 7 | 11.9 |
| 8 | 13.9 |
| 9 | 16.4 |
| 10 | 41.1 |

The compound containing Aerosil R106 silica (#10) gave a significantly higher compression set than those for the rest of the compounds. All the compounds comprising organo-neutralized diatomaceous earth gave relatively low compression set values, which may be a useful attribute for applications requiring good compression set properties (such as gaskets, o-rings, etc.). It is possible that the comparatively high compression set values for the Aerosil R106 containing compound were a consequence of the same phenomenon that was responsible for the “necking” behavior in the tensile stress-strain plots for this compound. Since the compression set was measured after subjecting the samples to 25% strain (at 175° C. for 22 hours), this observation suggests that there may have been significant differences in the compressive deformation and recovery behavior of the compounds comprising organo-neutralized diatomaceous earth from that of the compound comprising Aerosil R106.

### EXAMPLE 2

### Effect of Organoneutralized DE on Processability

Due in part to its small particle size and low density, fumed silica may adversely affect processability of certain silicone rubber formulations when used at high filler loading levels. For example, at filler levels exceeding about 12 to about 15%, fumed silica, fumed silica may displace enough resin to begin to effectively dry out a silicone rubber formulation, which may cause banding issues when the silicone rubber formulation fails to stick to the rollers in the mixing apparatus.

Use of high levels of fumed silica may also lead to undesirable thickening of certain silicone rubber formulations, leading to “crepe hardening” which may further interfere with processability. Crepe hardening is the stiffening of the uncured silicone elastomer that is caused by hydrogen bonding between the fumed silica reinforcing filler and the polymer fraction. Over time, the amount of hydrogen bonding increases and stiffening is observed. Crepe-aged silicones can be resoftened by shearing the material.

Processing agents, such as ∞,ω-dihydroxysilanes, have sometimes been used to offset at least some of the adverse effects on processability. However, those processing agents can be expensive and may have undesirable affects on the final properties of the cured rubber, such as reduced tensile strength.

The inventive organo-neutralized diatomaceous earth generally described above should provide a suitable alternative to fumed silica for use at higher loading levels. In some embodiments, the organo-neutralized diatomaceous earth may be relatively inexpensive and/or may be used at high filler levels without substantially adversely impacting mechanical properties.

For this example, formulations were prepared as depicted in Table 5 below. C350MC listed in Table 5 was one embodiment of an organo-neutralized diatomaceous earth described above—in particular, calcined diatomaceous earth (Celite 350 from World Minerals) treated with alkanolamine aminomethylpropanol (AMP) in an amount of 0.5%. The Mooney viscosity of these samples was measured in accordance with ASTM1646-06 at 100° C. Curing and molding characteristics were measured in accordance with ASTM 3182-05 at a cure temperature of 171° C. and a cure time of 5 to 8 minutes.

TABLE 5

| | | Aerosil | | | | Aerosil |
|---|---|---|---|---|---|---|
| | CONTROL | R106 | C350MC | C350MC | C350MC | R250 |
| Ingredients | | | | | | |
| Silastic 4758 | 50 | 50 | 50 | 50 | 50 | 50 |
| Silastic 4768 | 50 | 50 | 50 | 50 | 50 | 50 |
| DiCup 40 (peroxide Curative) | 1.25 | 1.25 | 1.25 | 1.25 | 1.25 | 1.25 |
| Filler | | 30 | 30 | 40 | 50 | 20 |
| TOTAL | 101.25 | 131.25 | 131.25 | 141.25 | 151.25 | 121.25 |
| Initial Mooney Viscosity, MU | 15.5 | 134.3 | 33.2 | 44.4 | 55.6 | 141.1 |
| Mooney Viscosity @ 4 min, | 13.1 | 70.1 | 23 | 28.89 | 35.59 | 73.8 |
| MU | | | | | | |
| Curing, Molding Data | | | | | | |
| Flow | Fair | Poor | Good | Good | Good | Fair |
| Release | Fair | Poor | Very | Good | Good | Fair |
| | | | Good | | | |
| Comment | Heavy | Very | No | Slight | Slight | Heavy |
| | Sticking | Heavy | Sticking | Sticking | Sticking | Sticking |
| | | Sticking | | | | |

As shown above, use of the organo-neutralized diatomaceous earth product as a filler in the tested silicone rubber formulations resulted in a sizeable decrease in Mooney viscosity (both initial and at 4 minutes) at loading levels as high as 50 phr, in comparison to 30 phr loading of coated fumed silica (Aerosil R106) and 20 phr loading of uncoated fumed silica (Aerosil R250). Those results suggest that the organo-neutralized diatomaceous earth disclosed herein provides improved processability.

The organo-neutralized diatomaceous earth was easily useable at loadings up to 50 phr. In comparison, both the coated and uncoated fumed silicas could only be loaded with difficulty at 30 and 20 phr, respectively. Formulations using high loadings (30-50 phr) of the organo-neutralized diatomaceous earth product were moldable with none to only slight sticking, and yielded acceptable final products. Again, these results suggest that use of the organo-neutralized diatomaceous earth described herein improves processability in comparison to use of fumed silica when used as a filler.

1-79. (canceled)

80. An organo-neutralized diatomaceous earth, comprising at least one diatomaceous earth comprising at least one acidic surface site at least partially neutralized by at least one basic organic compound.

81. The composition according to claim 80, wherein the at least one diatomaceous earth is chosen from the group consisting of natural, calcined, and flux-calcined diatomaceous earth.

82. The composition according to claim 80, wherein the at least one basic organic compound comprises at least one basic group chosen from the group consisting of amines and imines.

83. The composition according to claim 82, wherein the at least one basic group is at least one amine chosen from the group consisting of amino ethers, alkanolamines, aminosilanes, ethyleneamines, and aminoesters.

84. The composition according to claim 82, wherein the at least one basic group is at least one amine chosen from the group consisting of methylamine, ethylamine, diethylamine, 1,3-propanediamine, and primary, secondary and tertiary polyamines.

85. The composition according to claim 82, wherein the at least one basic group is at least one imine chosen from the group consisting of ethyleneimines and polyethyleneimines.

86. The composition according to claim 83, wherein the amino ether is chosen from the group consisting of polyether amines and morpholines.

87. The composition according to claim 83, wherein the alkanolamine is chosen from the group consisting of 2-amino-2-methyl-1-propanol, monoethanolamine, diethanolamine, triethanolamine, monoisopropanolamine, triisopropanolamine, diethylaminoethanol, methylethanolamine, dimethylethanolamine, ethylaminoethanol, amino-methypropanol, and alkanolamine aminomethylpropanol.

88. The composition according to claim 83, wherein the aminosilane is chosen from the group consisting of 3-aminopropyltrimethoxysilane, N-(2-aminoethyl)-3-aminopropyltrimethoxysilane, trimethoxysilylpropyldiethylenetriamine, 2-(trimethoxysilylethyl) pyridine, N-(3-trimethoxysilylpropyl)pyrrole, trimethoxysilylpropyl polyethyleneimine, bis-(2-hydroxyethyl)-3-aminopropyltriethoxysilane, and bis(2-hydroxyethyl)-3-amino propyltriethoxysilane.

89. The composition according to claim 83, wherein the ethyleneamine is chosen from the group consisting of ethylenediamine, diethylenetriamine, piperazine, N-aminoethylpiperazine, triethylenetetramine, tetraethylenepentamine, pentaethylenehexamine, and higher ethylenepolyamines.

90. The composition according to claim 80, wherein the at least one basic organic compound is alkanolamine aminomethylpropanol.

91. The composition according to claim 80, wherein the organo-neutralized diatomaceous earth has a pKa ranging from 4.0 to 7.0.

92. The composition according to claim 80, wherein the at least one basic organic compound is added in an amount from about 0.1% to about 5% relative to the total weight of the diatomaceous earth.

93. A silicone rubber composition comprising at least one silicone polymer and at least one filler comprising at least one organo-neutralized diatomaceous earth, wherein the at least one organo-neutralized diatomaceous earth comprises at least one surface acidic site at least partially neutralized by at least one basic organic compound.

94. The composition according to claim 93, wherein the at least one basic organic compound comprises at least one basic group chosen from the group consisting of amines, amino ethers, alkanolamines, aminosilanes, ethyleneamines, and aminoesters.

95. The composition according to claim 93, wherein the at least one basic organic compound is alkanolamine aminomethylpropanol (AMP).

96. The composition according to claim 93, wherein the at least one basic organic compound is added in an amount greater than 0.25% relative to the total weight of the diatomaceous earth.

97. The composition according to claim 93, wherein the organo-neutralized diatomaceous earth is present in an amount ranging from about 1 to about 200 phr in the composition.

98. The composition according to claim 93, wherein the Shore A hardness ranges from about 55 to about 90.

99. The composition according to claim 93, wherein the tensile strength ranges from about 1000 to about 1200 psi.
